(19) United States
(12) Patent Application Publication
(10) Pub. No.: US 2026/0159146 A1
(43) Pub. Date: Jun. 11, 2026

(54) Photography Equipment Cart Device

(71) Applicants: Rodney Williams, Baltimore, MD (US); Darline Page Williams, Baltimore, MD (US)

(72) Inventors: Rodney Williams, Baltimore, MD (US); Darline Page Williams, Baltimore, MD (US)

(21) Appl. No.: 19/179,555

(22) Filed: Apr. 15, 2025

Related U.S. Application Data
(60) Provisional application No. 63/634,982, filed on Apr. 17, 2024.

(51) Int. Cl. B62B 3/04; B60R 25/01; B60R 25/25

(52) U.S. Cl. CPC B62B 3/04; B60R 25/01; B60R 25/25

(57) ABSTRACT

A photography equipment cart device is provided. The device is comprised of a mobile cart that includes a frame, at least one shelf, and wheels for mobility. The shelves may also feature compartments with interior padding for protecting electronic equipment and doors with locking mechanisms, and recessed areas for securely holding items like cameras or batteries. Additionally, the device may incorporate a docking station fastener with a charging structure, and a portable power source equipped with charging ports, power ports, and a converter to provide AC power for electronics, such as cameras or computers, making it suitable for photography-related applications.

### CROSS-REFERENCE TO RELATED APPLICATION

The present application claims priority to, and the benefit of, U.S. Provisional Application No. 63/634,982, which was filed on Apr. 17, 2024, and is incorporated herein by reference in its entirety.

### FIELD OF THE INVENTION

The present invention relates generally to the field of mobile carts. More specifically, the present invention relates to a photography equipment cart device that provides a mobile cart with a plurality of receiving areas and power sources for photography-related equipment. Accordingly, the present disclosure makes specific reference thereto. Nonetheless, it is to be appreciated that aspects of the present invention are also equally applicable to other like applications, devices, and methods of manufacture.

### BACKGROUND

Individuals and businesses that produce on-the-spot products, such as photographers, often face the challenge of needing immediate access to electricity and a variety of tools and materials to create high-quality, professional-looking products. Photographers, in particular, require a reliable power source to operate essential equipment like photo printers, lighting systems, and cameras. In addition to power, they need storage compartments that can safely house delicate equipment and accessories, protecting them from damage during transport and use.

Transporting equipment by hand is not only cumbersome but also time-consuming and can lead to significant frustration, especially when moving between locations. The absence of a readily available power supply at a worksite can further complicate the situation, potentially preventing photographers from delivering finished products to their clients on the spot. This lack of immediate delivery capability might result in the need to distribute finished products at a later time, which could diminish customer satisfaction and reduce the perceived value of the service. Additionally, the inability to provide instant products can limit a photographer's competitiveness in situations where customers expect immediate gratification, such as events or pop-up studios. This highlights the importance of having a mobile, efficient solution that can address both power needs and equipment transport, ensuring photographers and similar professionals can deliver their best work wherever they are.

Therefore, there exists a long-felt need in the art for a device that can be used by photographers. More specifically, there exists a long-felt need in the art for a photography equipment cart device that can be used to transport and store photography equipment. In addition, there exists a long-felt need in the art for a photography equipment cart device that can be used to transport and store photography equipment, and wherein the device can protect said equipment during transport. Further, there exists a long-felt need in the art for a photography equipment cart device that can be used to transport and store photography equipment, protect said equipment during transport, and serve as a mobile workstation for photographers.

The subject matter disclosed and claimed herein, in one embodiment thereof, comprises a photography equipment cart device. The device is comprised of a mobile cart that includes a frame, at least one shelf, and wheels for mobility. The shelves may also feature compartments with interior padding for protecting electronic equipment and doors with locking mechanisms, and recessed areas for securely holding items like cameras or batteries. Additionally, the device may incorporate a docking station fastener with a charging structure, and a portable power source equipped with charging ports, power ports, and a converter to provide AC power for electronics, such as cameras or computers, making it suitable for photography-related applications.

In this manner, the photography equipment cart device of the present invention accomplishes all the forgoing objectives and provides a device that can be used to transport and store photography equipment. In addition, the device can protect said equipment during transport. Further, the device can serve as a mobile workstation for photographers.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a photography equipment cart device comprised of a cart comprised of at least one frame, at least one shelf, and at least one wheel. At least one shelf is attached to the frame. The shelf may be repositionable along the height of the frame or may be fixedly attached to the frame. The shelf may be any shape but is preferably square or rectangular. The wheel may be any wheel type that allows the device to be pushed, pulled, rolled, etc. via at least one handle.

In one embodiment, the shelf (or any other area of the device) is comprised of at least one compartment preferably comprised of an interior padding to protect electronic equipment from damage when stored within the compartment. The compartment is comprised of at least one door/lid that can be locked (such that valuables within the compartment cannot be accessed) via at least one locking mechanism.

The shelf may be comprised of at least one recessed area that may be shaped to receive any item such as but not limited to a camera, or batteries in order to prevent the camera or batteries from moving across the shelf while the device is in motion. In one embodiment, the shelf is comprised of at least one docking station fastener preferably comprised of a charging structure and a fastener to secure an item such as but not limited to a camera, a laptop, a computer, a printer, etc. to the shelf (or other area of the device).

The device may be comprised of at least one portable power source, such as but not limited to a portable battery. The power source may be comprised of at least one charging port to receive charge, at least one power port that can receive any type of charging cord to output power from the power source, and at least one power button that activates the power source to output power. In one embodiment, the power source is in wired electrical communication with at least one converter that converts stored power within the power source into usable AC power for photography-related electronics. The converter may be comprised of at least one female power outlet to receive charging cords.

Accordingly, the photography equipment cart device of the present invention is particularly advantageous as it provides a device that can be used to transport and store photography equipment. In addition, the device can protect said equipment during transport. Further, the device can serve as a mobile workstation for photographers. In this manner, the photography equipment cart device provides a solution to numerous problems faced by photographers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a photography equipment cart device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used by photographers. More specifically, there exists a long-felt need in the art for a photography equipment cart device that can be used to transport and store photography equipment. In addition, there exists a long-felt need in the art for a photography equipment cart device that can be used to transport and store photography equipment, and wherein the device can protect said equipment during transport. Further, there exists a long-felt need in the art for a photography equipment cart device that can be used to transport and store photography equipment, protect said equipment during transport, and serve as a mobile workstation for photographers.

The present invention, in one exemplary embodiment, is comprised of a photography equipment cart device. The device is comprised of a cart comprised of at least one frame, at least one shelf, and at least one wheel. At least one shelf is attached to the frame, wherein the shelf may be repositionable along the height of the frame or may be fixedly attached to the frame. The shelf may be any shape but is preferably square or rectangular. The wheel may be any wheel type that allows the device to be pushed, pulled, rolled, etc. via at least one handle.

In one embodiment, the shelf (or any other area of the device) is comprised of at least one compartment preferably comprised of an interior padding to protect electronic equipment from damage when stored within the compartment. The compartment is comprised of at least one door/lid that can be locked (such that valuables within the compartment cannot be accessed) via at least one locking mechanism.

The shelf may be comprised of at least one recessed area that may be shaped to receive any item such as but not limited to a camera, or batteries in order to prevent the camera or batteries from moving across the shelf while the device is in motion. In one embodiment, the shelf is comprised of at least one docking station fastener preferably comprised of a charging structure and a fastener to secure an item such as but not limited to a camera, a laptop, a computer, a printer, etc. to the shelf (or other area of the device).

The device may be comprised of at least one portable power source, such as but not limited to a portable battery. The power source may be comprised of at least one charging port to receive charge, at least one power port that can receive any type of charging cord to output power from the power source, and at least one power button that activates the power source to output power. In one embodiment, the power source is in wired electrical communication with at least one converter that converts stored power within the power source into usable AC power for photography-related electronics. The converter may be comprised of at least one female power outlet to receive charging cords.

Accordingly, the photography equipment cart device of the present invention is particularly advantageous as it provides a device that can be used to transport and store photography equipment. In addition, the device can protect said equipment during transport. Further, the device can serve as a mobile workstation for photographers. In this manner, the photography equipment cart device provides a solution to numerous problems faced by photographers.

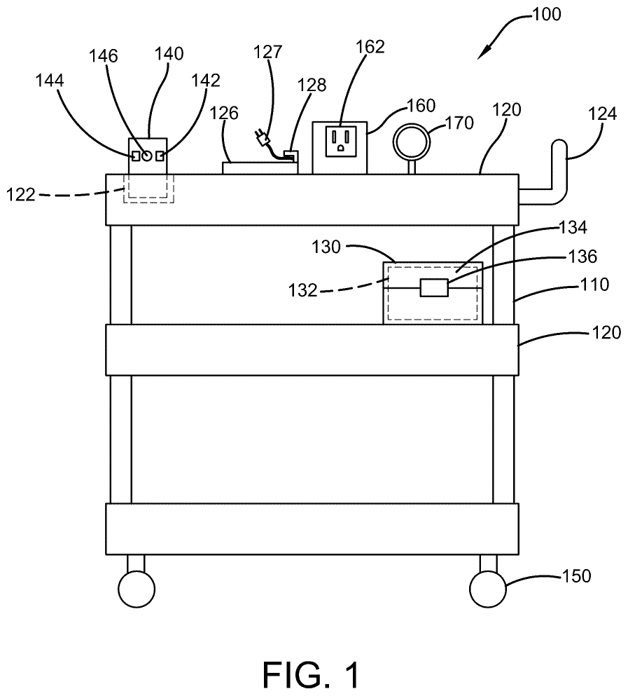

Referring initially to the drawings, FIG. 1 illustrates a perspective view of one potential embodiment of a photography equipment cart device 100 of the present invention in accordance with the disclosed architecture. The device 100 is comprised of a cart comprised of at least one frame 110, at least one shelf 120, and at least one wheel 150. The frame 110 is preferably generally square or rectangular but may be any shape. The frame 110 may be made from any material such as but not limited to metal, plastic, etc. At least one shelf 120 is attached to the frame 110. The shelf 120 may be repositionable along the height of the frame 110 or may be fixedly attached to the frame 110. The shelf 120 may be any shape but is preferably square or rectangular. The wheel 150 may be any wheel type that allows the device 100 to be pushed, pulled, rolled, etc. via at least one handle 124 (of any type/configuration) such as but not limited to a swivel caster wheel, a locking caster wheel, a pneumatic wheel, a rubber wheel, a polyurethane wheel, an anti-static wheel, etc.

In one embodiment, the shelf 120 (or any other area of the device 100) is comprised of at least one compartment 130. The compartment 130 may be any shape. The compartment 130 is preferably comprised of an interior padding 132 to protect electronic equipment from damage when stored within the compartment. The padding 132 may be any type such as but not limited to a foam padding. The compartment 130 is comprised of at least one door/lid 134. The door 134 can be locked (such that valuables within the compartment 130 cannot be accessed) via at least one locking mechanism 136 such as but not limited to a key lock, a biometric lock, a dial lock, a combination lock, a smart lock, etc.

The shelf 120 may be comprised of at least one recessed area 122. The recessed area 122 may be any shape to receive any item such as but not limited to a camera, or batteries in order to prevent the camera or batteries from moving across the shelf 120 while the device 100 is in motion. In one embodiment, the shelf 120 is comprised of at least one docking station fastener 126. The fastener 126 is preferably comprised of a charging structure 127 and a fastener 128 to secure an item such as but not limited to a camera, a laptop, a computer, a printer, etc. to the shelf 120 (or other area of the device 100).

The device 100 may be comprised of at least one portable power source 140, such as but not limited to a portable battery. The power source 140 may be comprised of at least one charging port 142 to receive charge, at least one power port 144 that can receive any type of charging cord to output power from the power source 140, and at least one power button 146 that activates the power source 140 to output power. In one embodiment, the power source 140 is in wired electrical communication with at least one converter 160. The converter 160 may be any wattage converter but is preferably at least one 200-watt converter that converts stored power within the power source 140 into usable AC power for photography-related electronics. The converter 160 may be comprised of at least one female power outlet 162 to receive charging cords.

In one embodiment, the device 100 is comprised of at least one light 170. The light 170 can be a repositionable or fixed light in different embodiments. The light 170 may be any light type such as but not limited to a ring light, a strobe light, a flash light, a continuous light, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “photography equipment cart device” and “device” are interchangeable and refer to the photography equipment cart device 100 of the present invention.

Notwithstanding the forgoing, the photography equipment cart device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the photography equipment cart device 100 as shown in the FIGS. are for illustrative purposes only, and that many other sizes and shapes of the photography equipment cart device 100 are well within the scope of the present disclosure. Although the dimensions of the photography equipment cart device 100 are important design parameters for user convenience, the photography equipment cart device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A photography equipment cart device comprising:
a frame;
a shelf attached to the frame, the shelf comprised of a recessed area;
a compartment;
a portable power source;
a converter;
a wheel attached to the frame; and
a handle attached to the frame.

2. The photography equipment cart device of claim 1, wherein the wheel is comprised of a swivel caster wheel, a locking caster wheel, a pneumatic wheel, a rubber wheel, a polyurethane wheel, or an anti-static wheel.

3. The photography equipment cart device of claim 1, wherein the compartment is comprised of an interior padding.

4. The photography equipment cart device of claim 1 further comprised of a docking station fastener.

5. The photography equipment cart device of claim 4, wherein the docking station fastener is comprised of a charging structure.

6. The photography equipment cart device of claim 4, wherein the docking station fastener is comprised of a fastener.

7. A photography equipment cart device comprising:
a frame;
a shelf attached to the frame, the shelf comprised of a recessed area;
a compartment comprised of a lid and a locking mechanism;
a portable power source;
a converter;
a wheel attached to the frame; and
a handle attached to the frame.

8. The photography equipment cart device of claim 7, wherein the locking mechanism is comprised of a key lock, a biometric lock, a dial lock, a combination lock, or a smart lock.

9. The photography equipment cart device of claim 7, wherein the portable power source is comprised of a charging port.

10. The photography equipment cart device of claim 7, wherein the portable power source is comprised of a power port.

11. The photography equipment cart device of claim 7, wherein the portable power source is comprised of a power button.

12. A photography equipment cart device comprising:
a frame;
a shelf attached to the frame in a repositionable manner, the shelf comprised of a recessed area;
a compartment comprised of a lid and a locking mechanism;
a portable power source;
a converter comprised of a power outlet;
a wheel attached to the frame; and
a handle attached to the frame.

13. The photography equipment cart device of claim 12, wherein the power outlet is comprised of a female power outlet.

14. The photography equipment cart device of claim 12, wherein the converter is comprised of a 200-watt AC converter.

15. The photography equipment cart device of claim 12, wherein the power source is in wired communication with the converter.

16. The photography equipment cart device of claim 12, wherein the locking mechanism secures the lid.

17. The photography equipment cart device of claim 12, wherein the locking mechanism is comprised of a key lock, a biometric lock, a dial lock, a combination lock, or a smart lock.

18. The photography equipment cart device of claim 12, wherein the padding is comprised of a foam padding.

19. The photography equipment cart device of claim 12, wherein the shelf is comprised of a rectangular shelf.

20. The photography equipment cart device of claim 12, wherein the frame is comprised of a metal material.
